(19) United States
(12) Patent Application Publication
(10) Pub. No.: US 2005/0247221 A1
(43) Pub. Date: Nov. 10, 2005

(54) Method and apparatus for producing printing forms

(75) Inventor: Peer Dilling, Friedberg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/121,647

(22) Filed: May 4, 2005

(30) Foreign Application Priority Data
May 5, 2004 (DE) 10 2004 022 180.4

(51) Int. Cl. B41N 3/00

(52) U.S. Cl. 101/401.1; 101/463.1

(57) ABSTRACT

A method for producing a printing form of a rewritable type erases the surface of the printing form and than images the erased surface to provide a permanent and erasable image on the surface. The erasure and imaging of the surface of the printing form are carried out in such a way that only at least one selected section or region of the surface, rather than the entire surface, of the printing form is erased and re-imaged.

### FIELD OF THE INVENTION

The invention relates to printing forms, and more particularly to a method and apparatus for preparing printing forms of a rewritable type.

### BACKGROUND OF THE INVENTION

During printing with a printing form, in principle a distinction is drawn between methods which operate on the one hand with a printing form that can be written once or on the other hand with a rewritable printing form. Printing methods which use rewritable printing forms are also brought together under the keyword “computer to press/direct imaging.” The present invention here relates to a method and an apparatus for producing a permanent and erasable image on such a rewritable printing form.

Under the product description “DICOweb”, the assignee of this invention markets digital presses which operate with rewritable and erasable printing forms. During the production of such printing forms, a basic printing form cylinder is preferably subjected to an erasure step and an imaging step. An erasing apparatus which can be used when erasing such a printing form is disclosed, for example, in DE 100 08 214 A1. DE 100 23 319 A1 discloses a device for imaging such printing forms. With regard to further principles of the DICOweb technology, reference can be made to “Handbuch der Printmedien” [Printing Media Manual], Helmut Kipphan, pages 674-680, 2000, Springer-Verlag.

According to the prior art, during the production of rewritable printing forms of this type, the procedure is such that the entire printing form is always erased or de-imaged and is then re-imaged. Because the entire printing form is always erased and then imaged, the result is relatively long changeover times on presses operating with such printing forms.

### BRIEF SUMMARY OF THE INVENTION

In view of the foregoing, it is an object of the present invention to provide a novel system and method for producing printing forms of the rewritable type that can be rewritten quickly with a new image.

This object is achieved by a method for producing printing forms according to the invention, in which the erasure and the imaging are carried out along the printing form in such a way that only at least one selected section or region of the surface, rather than the entire surface, of the printing form is erased and re-imaged.

In accordance with the invention, the erasure and imaging are carried out along the printing form only in selected sections or regions of the surface of the printing form. This makes it possible to adapt only specific regions of the cylindrical printing form to a new print job, which means that changeover times on the press can be reduced considerably. The regions of the surface of the cylindrical printing form that are to be erased and re-imaged are sections of the cylindrical surface of the printing form in the direction of a cylinder longitudinal axis and/or in the direction of a cylinder circumference.

The apparatus according to the invention for producing a permanent and erasable image on a surface of a printing form has at least one erasing device for erasing the surface and an imaging device for imaging the erased surface. The erasing device and the imaging device are constructed in such a way that the erasure and the imaging can be carried out in only at least one selected region of the printing form that is less than the entire surface of the printing form.

An exemplary embodiment of the invention will be explained in greater detail below with reference to the drawing.

### BRIEF DESCRIPTION OF THE DRAWING

FIG. 1 shows, in a schematic form, an embodiment of an apparatus according to the invention for producing a printing form by erasing and then imaging the surface of the printing form.

### DETAILED DESCRIPTION OF THE INVENTION

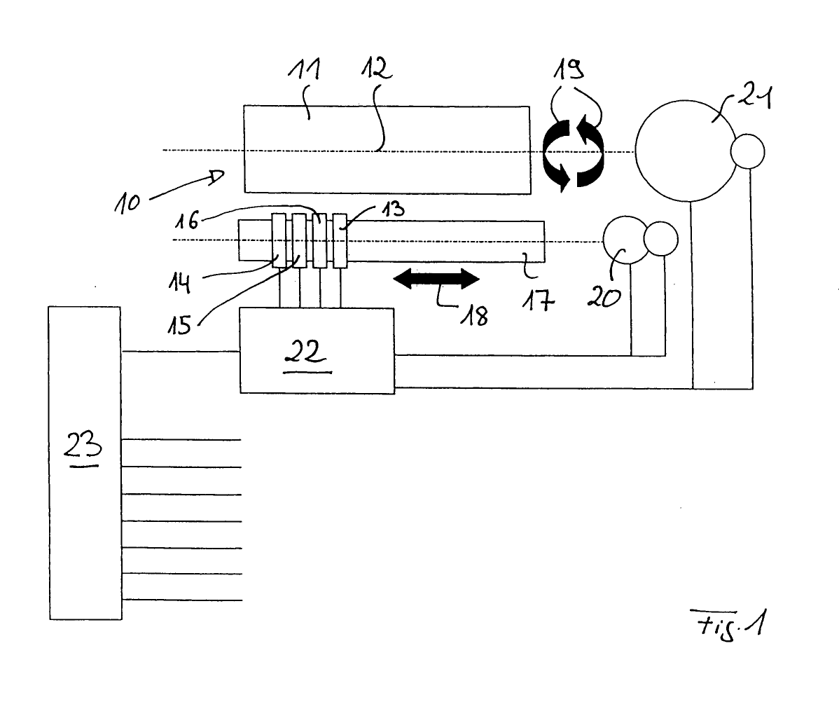

In the following text, with reference to FIG. 1, the invention will be described by way of example for offset printing by the DICOweb technology, the offset printing variant of the DICOweb technology also being designated “DICOweb litho.”

FIG. 1 shows a schematic illustration of an embodiment of the apparatus according to the invention for producing a permanent and erasable image on a rewritable printing form 10, namely on a surface 11 of the same. As used herein, the phrase “permanent and erasable” means that the image formed on the surface 11 is long-lasting but can be erased by means of a suitable erasing method. The rewritable printing form 10 is preferably cylindrical, a central longitudinal axis of the printing form 10 being identified by the reference number 12 in FIG. 1.

In order to provide a permanent and erasable image on the surface 11 of the printing form 10, steps including erasure of the surface 111 of the printing form 10, imaging of the surface 11 and, if appropriate, fixing and conditioning of the imaged surface are carried out. For this purpose, the apparatus according to the invention has appropriate devices, namely an erasing device 13, an imaging device 14, a fixing device 15 and a conditioning device 16 for performing the respective steps.

As can be seen from FIG. 1, all the devices 13, 14, 15 and 16 can moved in the longitudinal direction of the printing form 10, relative to the printing form 10 or surface 111 of the same, along a crossmember 17. The direction of the movement is depicted by the arrow 18. As the devices 13, 14, 15 and 16 are moved in the longitudinal direction of the printing form 10, the printing form 10 remains stationary in the longitudinal direction but is rotated about the central longitudinal axis 12 in the direction of the arrows 19. FIG. 1 shows a motor drive 20 for the devices 13 to 16 for the common movement of the same along the crossmember 17, and also a motor drive 21 to ensure rotation of the printing form 10 about the central longitudinal axis 12 of the same.

In accordance with a feature of the present invention, the production or provision of a permanent and erasable image on the surface 11 of the printing form 10 is carried out in such a way that the erasure and the imaging of the surface 111 of the printing form 10 is carried out only in at least one selected section or region of the surface 11 of the printing form 10 that is less than the entire surface of the printing form. Accordingly, in order to adapt the printing form 10 to a new print job, only specific regions or sections of the surface 11 have to be erased and re-imaged. For this purpose, the corresponding devices 13, 14, 15 and 16 are moved along the crossmember 17 to the section of the surface 111 to be erased and to be re-imaged and the re-imaging of the printing form 10 is then carried out only in these sections.

In order to carry out the method according to the invention, all the devices 13, 14, 15 and 16 which are needed to erase and to re-image the respective sections of the surface 111 of the printing form 10 can be actuated digitally and operate digitally with a sufficiently high resolution, preferably with a resolution in the region of 5 μm. As can be gathered from FIG. 1, for this purpose the devices 13, 14, 15 and 16 interacting with the printing form 10 are assigned a control device 22 which, firstly, actuates the devices 13 to 16 and, secondly, actuates the drives 20 and 21.

This control device 22 is in turn actuated by a machine control system 23 of the press, which is also connected to further control devices 22 assigned to other printing forms 10. At least one printing form 10 of this type having the corresponding devices 13 to 16 and 20 to 22 is preferably integrated into every printing unit of a press. Accordingly, the method according to the invention is preferably carried out within the press.

In accordance with the present invention, a permanent and erasable image on a reusable printing form is not provided (by being erased and re-imaged) over the entire width and length of the printing form but, instead, only selected sections or regions less than the entire surface 11 are changed in order to adapt the printing form to a new print job. In this way, expenditure on time and costs during the adaptation of the press to a changed print job can be reduced considerably.

In the case of offset printing by “DICOweb litho,” according to the invention, a section of the surface 111 of the printing form 10 to be re-imaged is erased by using a laser, the erased region subsequently preferably being re-imaged via a thermal transfer ribbon in conjunction with the laser. The fixing and conditioning of the re-imaged section or region of the printing form are likewise carried out only locally in the re-imaged sections of the printing form. The fixing is preferably likewise carried out by means of the laser, which warms or heats the re-imaged section of the surface 11 of the printing form 10.

Although the present invention here has been described by using the example of offset printing, it is obvious that the invention can also be used for producing a gravure printing form, that is to say can be used in conjunction with the “DICOweb gravure” method.

For this purpose, the bowl-like depressions in the surface 11 of the printing form 10, positioned in the sections of the printing form to be adapted, are then de-imaged or erased and the depressions are refilled only in these regions, for example via a squeegee. After these bowl-like depressions have been filled, re-imaging of these sections or regions is then carried out locally in these sections of the surface 11 of the printing form 10.

1. A method for producing a printing form within a press, comprising:
providing a printing form having a rewritable surface;
erasing only at least one selected region of the surface of the printing form, said at least one selected section being less than the entire surface of the printing form; and
imaging only the at least one selected region of the surface of the printing form.

2. A method according to claim 1, wherein the steps of erasing and imaging include moving respective erasing and imaging devices relative to the printing form in a longitudinal direction of the printing form over said at least one selected region of the surface.

3. A method according to claim 1, further including a step of moving a fixing device over said at least one selected region to fix an image formed in said at least one selected region.

4. A method according to claim 3, further including a step of moving a conditioning over said at least one selected region to condition the image formed in said at least one selected region, after or before the fixing step.

5. A method according to claim 1, wherein the steps of erasing and imaging include moving corresponding erasing and imaging devices relative to the printing form in a longitudinal direction of the printing form over said at least one selected region of the surface while the printing form is stationary in the longitudinal direction and rotating about a central longitudinal axis.

6. A method according to claim 5, wherein the erasing and imaging devices are actuated digitally by a control device.

7. An apparatus for producing a permanent and erasable image on a surface of a printing form within a press, comprising:
an erasing device for erasing the surface of the printing form;
an imaging device for imaging the erased surface of the printing form; and
a controller for controlling operations of the erasing and imaging devices, wherein the controller is programmed to control the erasing and imaging devices to erase and then image only at least one selected region less than an entire surface of the printing form.

8. An apparatus according to claim 7, wherein the erasing device and imaging device are movable relative to the printing form.

9. An apparatus according to claim 7, wherein the erasing device and imaging device are actuated digitally by the controller.

10. An apparatus according to claim 7, further including a fixing device for fixing an image formed in the at least one selected region, and wherein the fixing device is movable relative to the printing form and actuated digitally by the controller.

11. An apparatus according to claim 7, further including a conditioning device for conditioning an image formed in the at least one selected region after or before it is fixed by the fixing device, wherein the conditioning device is movable relative to the printing form and actuated digitally by the controller.
